(19) United States
(12) Patent Application Publication
(10) Pub. No.: US 2001/0040214 A1
(43) Pub. Date: Nov. 15, 2001

(54) Method and apparatus for extending particle image velocimetry to determine particle size and three dimensional velocity

(76) Inventors: Jacob A. Friedman, Waterloo (CA); Metin Renksizbulut, Waterloo (CA)

Correspondence Address: Kenneth C. Winterton, SHERIDAN ROSS P.C., 1560 Broadway, Suite 1200, Denver, CO, 80202-5141, US

(21) Appl. No.: 09/808,525

(22) Filed: Mar. 13, 2001

Related U.S. Application Data
(60) Provisional application No. 60/188,739, filed on Mar. 13, 2000.
(60) Provisional application No. 60/192,031, filed on Mar. 24, 2000.

(51) Int. Cl. H01J 49/00; B01D 59/44

(52) U.S. Cl. 250/287

(57) ABSTRACT

An apparatus and method that can allow a standard PIV systems to obtain particle size as well as the third velocity component with minimal hardware modifications. The invention is based on using two radiation sheets of different wavelength ranges, overlapped with a known offset. By obtaining simultaneous images filtered for each wavelength, the scattering particle's location within the radiation sheet can be established. Once its location is known, its size can be determined through intensity measurements, and the third velocity component determined from position change between exposures.

Priority is claimed from U.S. Provisional Patent No. 60/188,739, filed Mar. 13, 2000 entitled “A Method For Extending PIV To Determine Particle Size And 3-D Velocity,” and U.S. Provisional Patent No. 60/192,031, filed March 24, 2000 entitled “A Method For Extending Particle Image Velocimetry (PIV) To Determine Particle Size And 3-D Velocity,” both of which are incorporated by reference in their entirety.

### FIELD OF INVENTION

A method and apparatus for measuring the position and velocity of a particle in three dimensions and for measuring the size of a particle. The method and apparatus employ two overlapping sheets of radiation, each having a different wavelength range and known nonuniform intensity distribution.

### BACKGROUND OF INVENTION

Particle image velocimetry (PIV) has, in recent years, become an attractive method for characterizing flow velocities due to its relative ease of application and its wide field data acquisition. However, in Maynert, R., Applied Optics 22:535-540 (1983) and in Warnet, M. P., Applied Optics 30:1839-1846 (1991) the technique is generally applicable to single phase flows seeded with low spatial densities of small scattering particles that accurately track the flow. In addition, only two components of velocity are generally attainable unless elaborate systems incorporating multiple cameras are used, for example, as disclosed in Hinsch, K. D., Measurement Science and Technology 6:742-753 (1995) and in Zhang, W., Prasad, A. K., Applied Optics 36:8738-8744 (1997). A simpler technique for determining three components of velocity described by Cedanese, A. and Paglialunga, A., Experiments in Fluids 8:228:230 (1989) using parallel light sheets has shown some promise and forms the basis for this invention. In multi-phase flows such as spray/air systems, PIV cannot be reliably used to map gas-phase flow velocity as a typical PIV system cannot distinguish a seed particle accurately following the gas-phase flow from a large spray droplet with its own momentum-driven trajectory.

Some enhanced PIV processing methods have been developed which allow determination of the scattering particle size (and thus discrimination between seed particles and large spray droplets), including streak PIV (SPIV), as disclosed in Herpfer, D. C., Jeng, S. M., “Streaked Particle Imaging Velocimetry and Sizing in Burning and Non-Burning Sprays” AIAA Paper 95-0141, 1995. A technique disclosed in Kadambi, J. R., Martin, W. T., Amirthaganesh, S., Wernet, M. P., Powder Technology 100:251-259 (1998) uses the light distribution of a particle's image to extract particle size. Both techniques have been successfully demonstrated, though neither technique allows determination of the third component of velocity. In addition, the technique described in Kadambi et al. is limited to relatively small fields of view as each particle image at the charge coupled device (CCD) plane must cover several pixels to allow determination of image light distribution.

It would be advantageous to provide a method and apparatus for simultaneously determining particle size and for determining particle position and velocity in three dimensions. It would be advantageous if the method and apparatus were not much more complicated than prior art devices used to measure particle velocity in two dimensions. It would also be advantageous to provide a system that determines individual particle sizes of each particle contained in an arbitrarily large volume in a single measurement.

### SUMMARY OF THE INVENTION

In accordance with one embodiment of the present invention, a particle measuring apparatus is provided. The apparatus includes a radiation source for providing two offset sheets of radiation, each having a different wavelength range and known intensity distribution. The particles to be measured pass through the two radiation sheets. The apparatus also includes a measuring device preferably including a CCD camera and filtered image splitter or two separate CCD cameras with filters to provide two sets of two separate simultaneous images, each of the separate simultaneous images filtered for one of the radiation sheet wavelength ranges, of the particles in the illuminated field with known time intervals between the first set of two separate simultaneous images and the second set of two separate simultaneous images. The apparatus also includes a device for calculating the particle position and/or velocity in accordance with the measured particle's scattered radiation intensity and the intensity ratio of each filtered image. Preferably, the calculating device calculates the particle's velocity by comparing the particle position in the first image set to the corresponding position in the second image set, thus determining the particle's displacement in three dimensions, then dividing by the time interval between the first and second image sets, thus determining the particle=3 s velocity.

In accordance with another embodiment of the present invention, an apparatus for determining the size and/or position of at least one particle is provided. The apparatus includes at least one radiation source capable of providing two overlapping offset radiation sheets of different wavelengths and known nonuniform intensity distribution. The apparatus also includes a device for measuring the radiation intensity scattered by a particle passing through the two radiation sheets. The apparatus also includes a device for calculating at least one of particle size and position in accordance with the measured particle's scattered radiation intensity and the intensity ratio from each of the radiation sheets. Preferably, the radiation source includes optics to provide two overlapping, offset radiation sheets of different wavelengths and known nonuniform intensity distribution. Preferably the known nonuniform intensity distribution is a Gaussian distribution. Preferably the device for measuring the scattered radiation intensity includes a CCD camera and filtered image splitter or two separate CCD cameras with filters capable of providing two separate, simultaneous images, each filtered for one of radiation sheets' wavelength ranges.

Preferably the device for calculating particle size and/or position calculates the particle's position in the plane of the radiation sheets in the z- and y- directions from the particle's position on the image, and the particle's position within the radiation sheets in the x- direction from the intensity ratio of the particle image in the two filtered images, wherein y- is the position in the plane of the light sheet normal to the direction of propagation and z- is the position in the direction of propagation of the light sheets and x- is the position within the light sheet normal to the light sheet plane. Preferably the radiation source includes a laser. Preferably the radiation source includes optics to generate the radiation sheets, more preferably the optics include two prisms. Preferably the radiation source includes either multi-line lasers or gas lamps, such as mercury vapor or sodium lamps. Preferably, the intensity ratio of the two color sheets' overlap region is a monotonic function of position. Preferably, the optics comprise cylindrical and spherical optics to generate light sheets, of desired thickness. Preferably the radiation source is selected from the group comprising a single radiation source capable of emitting radiation in two different wavelength ranges or two separate radiation sources capable of providing radiation in two different wavelength ranges.

In accordance with another embodiment of the present invention, a method is provided for determining the size or position of at least one particle. The method includes the steps of providing two overlapping offset radiation sheets of different wavelengths and known nonuniform intensity distribution, measuring the radiation intensity scattered by a particle passing through the two radiation sheets, and calculating at least one of particle size and/or position in accordance with the measured particle's scattered radiation intensity and the intensity ratio from each of the radiation sheets. Preferably, the particle position is calculated by calculating the particle's position in the plane of the radiation sheet in the z- and y- directions from the particle's position on the image, and the particle's position within the radiation sheets in the x- direction from the intensity ratio of the particle image in the two filtered images. Preferably, the method includes calculating at least one of a particle's position and velocity in three dimensions and a particle's size. Preferably, the method includes calculating all of a particle's position and velocity in three dimensions and a particle's size.

In accordance with the present invention, an apparatus and method are provided capable of determining one or more of a particle's position and velocity in three dimensions and a particle's size. In accordance with the present invention, the apparatus and method are straightforward and uncomplicated, when compared to prior art devices which were limited to measuring velocity and position in two dimensions.

### BRIEF DESCRIPTION OF THE DRAWINGS

FIG. 1 is a graphical representation of the intensity distribution of overlapped radiation sheets.

FIG. 2 is a graphical representation of the intensity ratios for δ/t=0.1, 0.2 and 0.5 with t₁=t₂.

FIG. 3 is a schematic representation of an optical arrangement in accordance with the present invention.

FIG. 4 is a graphical representation of the effective sheet width versus scatterer diameter for G=800.

FIG. 5 is a graphical representation of the measured and modeled light intensity distribution in green and blue light sheets.

FIG. 6 is a graphical representation of the measured intensity ratio versus position for a 3.18 mm (⅛″) sample.

FIG. 7 is a graphical representation of the intensity versus sample diameter at an arbitrary location within the light sheets.

FIG. 8 is a graphical representation of the intensity ratio versus position for all samples tested.

### DETAILED DESCRIPTION OF THE INVENTION

The invention described herein is directed to a method and apparatus for extending PIV to allow measurement of scattering particle size as well as three components of velocity and position with minimal modifications to a standard two dimensional PIV system.

The following Nomenclature will be employed throughout the present application:

### NOMENCLATURE

c Constant

d Scattering particle diameter

G Imaging system range ratio

h Radiation sheet half-height (1/e²)

I Intensity

r Radial position

t Radiation sheet half-thickness (1/e²)

W Effective radiation sheet width

x, y, z Spatial coordinates

δ Radiation sheet separation distance

Subscripts

1, 2 Radiation sheets 1 and 2

0 Centerline

b Bounding value

i index, i=1 or2

inc Incident

max Maximum value

ref Reference value

Sc Scattered

w Beam waist

x Function of x

y Function of y

A particle illuminated uniformly from one direction will scatter radiation anisotropically through 4π, sr. The intensity distribution of the scattered radiation will be a function of the scattering mode and particle geometry, as well as particle index of refraction if it is non-opaque. Typically, for particles larger than the incident radiation wavelength, the dominant scattering modes are reflection and first order refraction (for non-opaque particles), except in the forward direction where Fraunhauffer diffraction may also be significant. The intensity of radiation scattered in a given off-axis direction by reflection and refraction scale with particle diameter squared, and for particles larger than the incident radiation wavelength, the scattered radiation spatial distribution is well described using geometric optics theory, see Van de Hulst, H. C., Light Scattering by Small Particles, Dover Publications, 1981, p. 200, which is incorporated herein by reference in its entirety. Thus, in principle, it is possible to determine particle size by measuring the scattered radiation intensity at a point in space if the optical properties of the particle are known, and if the illumination intensity is known. However, in a system illuminated by a radiation sheet (such as a PIV system) with a Gaussian or other nonuniform intensity distribution, the illumination intensity is not known as it varies with position within the sheet. A measured high scattered intensity could be the result of a small particle illuminated near the sheet center, or a large particle illuminated near the sheet periphery. Thus, without a method for locating the particle within the radiation sheet, the illumination intensity is unknown and the particle size based on scattered radiation intensity is indeterminate.

It is possible to determine the particle location within the radiation sheet if two sheets of known intensity distribution and of different wavelength ranges are overlapped. The following discussion assumes the radiation sheets are collimated and generated from Gaussian radiation beams using cylindrical optics, producing parallel overlapped radiation sheets, but the theory is applicable to many other possible radiation intensity distribution functions and non-collimated and non-parallel sheets. It is expressly intended that the present invention cover radiation intensity distributions other than Gaussian distributions and non-collimated or non-parallel radiation sheets. One skilled in the art can adapt the calculations set forth below to determine particle position in three dimensions, particle velocity in three dimensions and particle size in such alternative embodiments without undue effort.

Consider a collimated radiation sheet generated from a Gaussian laser beam having an intensity distribution described by:

$$I ( r ) = {I}_{0} exp [ - \frac{2 {r}^{2}}{{r}_{w}^{2}} ] \qquad ( 1 )$$

When expanded into a collimated sheet of half-height h in the y direction, half-thickness t in the x direction and propagating in the z direction (where ∂I/d ∂z=0 ), the intensity distribution can be approximated by:

$$I ( x , y ) = {I}_{y} exp [ - \frac{2 {x}^{2}}{{t}^{2}} ] \qquad ( 2 )$$

$${I}_{y} = {I}_{0} exp [ - \frac{2 {y}^{2}}{{h}^{2}} ] \qquad ( 3 )$$

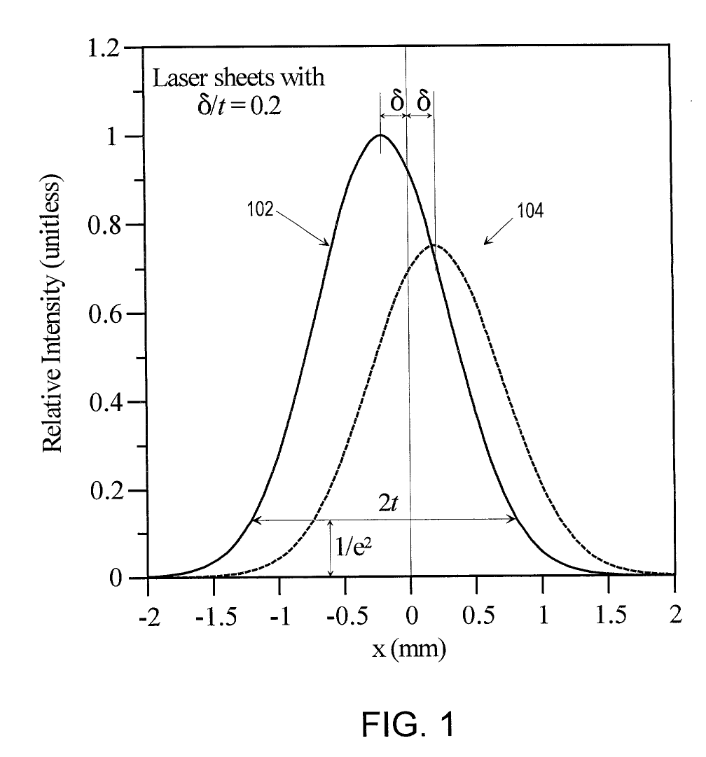

If two radiation sheets of wavelength ranges 1 and 2 are overlapped with an offset of 2δ, the resulting intensity distribution functions at an arbitrary y position are shown in FIG. 1, with wavelength range 1 represented by solid curve 102 and wavelength range 2 represented by dashed curved 104, and are given by:

$$\begin{matrix}{I}_{1} ( x , y ) = {I}_{y , 1} exp [ - \frac{2 {( x + δ )}^{2}}{{t}_{1}^{2}} ] & ( 4 ) \\ {I}_{2} ( x , y ) = {I}_{y , 2} exp [ - \frac{2 {( x - δ )}^{2}}{{t}_{2}^{2}} ] & ( 5 )\end{matrix}$$

The vertical distribution functions are again given by:

$$\begin{matrix}{I}_{y , 1} = {I}_{01} exp [ - \frac{2 {y}^{2}}{{h}_{1}^{2}} ] \\ & ( 6 ) \\ {I}_{y , 2} = {I}_{02} exp [ - \frac{2 {y}^{2}}{{h}_{2}^{2}} ] & ( 7 )\end{matrix}$$

An object illuminated by overlapped radiation sheets would scatter light in proportion to its diameter squared, and in proportion to the illuminating intensity of each wavelength range, which are functions of the particle's location within the radiation sheet. The ratio of intensity of each radiation wavelength range scattered by a particle is a function of the particle's position within the light sheet, and independent of its size. Thus:

$$\frac{{I}_{1} ( x , y )}{{I}_{2} ( x , y )} = \frac{{I}_{y , 1}}{{I}_{y , 2}} exp [ - 2 ( \frac{{( x + δ )}^{2}}{{t}_{1}^{2}} - \frac{{( x - δ )}^{2}}{{t}_{2}^{2}} ) ] \qquad ( 8 )$$

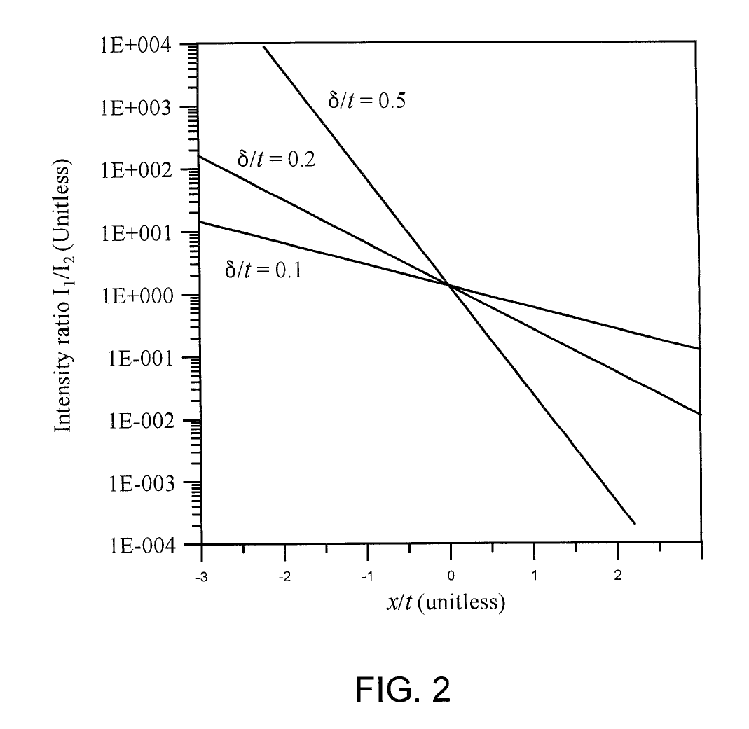

FIG. 2 shows the intensity ratio I₁(x,y)/I₂(x,y) at an arbitrary y position for t₁=t₂. As can be seen, the intensity ratio is a monotonic function of x, and thus uniquely determines the particle's position for this case. For cases where t₁#t₂, as long as they are of similar magnitude, the intensity ratio remains a monotonic function of x in the region where illumination intensity is sufficient to produce a detectable signal, becoming non-monotonic only at the extreme edges of the sheets.

A typical PIV system images the flow field normal to the illuminating sheet, and thus the PIV image can be used to directly obtain the y position of the particle within the sheet. Separate sheet characterization can be used to find the vertical intensity distribution ratio I_{y,1}/I_{y,2} as well as t. Imaging optics such as Princeton Instrument's MultiViewer using appropriate filtration can be used to obtain separate, simultaneous particle images on a CCD or other imaging device from wavelength ranges 1 and 2, and the intensity ratio I₁(x,y)I₂(x,y) determined from the measured intensity. From this information, the x position of the scattering particle can be determined from equation (8). Once the particle location within the illuminating sheet has been determined, the illuminating intensity is also known, and hence particle size can be determined by comparing the scattered intensity to that of a reference particle of similar optical properties and geometry. The intensity of radiation scattered by a spherical particle in a given direction is given by:

ti I_{SC}=I_{inc}cd²(9)

The constant of proportionality c is a function of particle index of refraction, incident radiation polarization, direction and distance to receiver, but is independent of particle size for particles larger than the incident wavelength range. Hence, for a given system geometry and fixed particle optical properties, c is constant. Assuming the illuminating sheets are well collimated such that there are no intensity variations in the z direction:

I(x,y,d)=I_{x,y}cd² (10)

Obtaining I as an absolute value in intensity units can be difficult, and determination of the constant of proportionality c is also not straight forward. However, intensity ratios are easier to obtain. For a given system geometry and particle optical properties, a reference intensity from a particle of known size can be obtained from an arbitrary reference position within the sheets:

I_{ref}(X_{ref}, y_{ref},d_{ref})=I_{xy,ref}cd_{ref}² (11)

Assuming (but not limited to) a Gaussian intensity distribution, the above expands to:

$${I}_{ref} ( {x}_{ref} , {y}_{ref} , {d}_{ref} ) = {I}_{01} exp [ - \frac{2 {y}_{ref}^{2}}{{h}^{2}} ] exp [ - \frac{2 {( {x}_{ref} + δ )}^{2}}{{t}^{2}} ] {cd}_{ref}^{2} \qquad ( 12 )$$

The size of an unknown particle can be determined by the ratio of the unknown particle scattered intensity to that of the reference as follows:

$$\frac{{d}^{2}}{{d}_{ref}^{2}} = \frac{I ( x , y , d )}{{I}_{ref} ( {x}_{ref} , {r}_{ref} , {d}_{ref}} \cdot exp [ \frac{2 ( {y}^{2} - {y}_{ref}^{2} )}{{h}^{2}} - \frac{2 [ {( {x}_{ref} + δ )}^{2} - {( x + δ )}^{2} ]}{{t}^{2}} ] \qquad ( 13 )$$

The absolute intensity I₀ and the constant of proportionality c do not appear in the above, leaving only terms that can easily be determined. The above development is valid for both wavelength ranges, thus producing two sets of values for d which can be compared for validation.

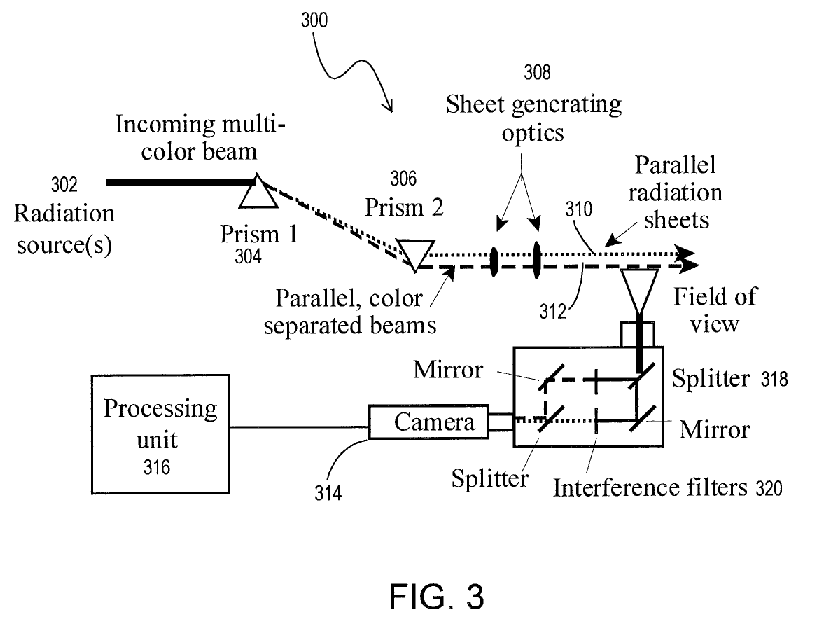

A typical PIV system 300 in accordance with the present invention consists of one or more radiation sources 302. If a single incoming multiwavelength (e.g., multicolor) beam is employed, as shown in FIG. 3, prisms 304 and 306 can be employed to split the incoming beam into separate, preferably parallel beams having different wavelength ranges. The parallel color separated beams have different wavelength ranges. As used herein, the term “wavelength ranges” can refer to any wavelength or range of wavelengths, as long as the two different wavelength ranges are discernable from each other. For example, in the illustrative example described herein, the two wavelength ranges are discerned by filtering each of the respective wavelength ranges in order to obtain separate images that can be discerned by the image collector, e.g., a CCD camera 314. Therefore, the wavelength ranges can be very narrow, such as a single wavelength, or broad. The wavelength ranges can also overlap, as long as the filters filter out the overlapping region.

One embodiment of the system 300 of the present invention includes associated radiation sheet-generating optics 308 to generate parallel radiation sheets 310 and 312, a CCD camera 314 or other imaging device, and a processing unit 316. The processing unit 316 can be any suitable device capable of receiving radiation intensity data from the imaging device and calculating the particle's position and/or velocity in three dimensions and/or size. For example, a high speed digital calculating unit, such as a electronic computer can be employed. However, it will be understood by one skilled in the art that any processing unit capable of receiving the data and making the requisite calculations can be used in connection with the present invention. The system 300 obtains two images of particles in the flow field with a known time delay between images, then uses cross-correlation techniques (or other methods) to compute the two dimensional motion of the seed particles during the time increment to obtain the velocity field. In order to apply the two wavelength range offset sheet technique described above to obtain the third velocity component, image splitting optics 318 and appropriate filtration 320 can be employed to obtain simultaneous, adjacent images on the CCD chip or other imaging device of the particles illuminated by each of the laser sheets. Other devices and methods can be employed to obtain scattered radiation intensity data for the particle illuminated by the two radiation sheets. For example, instead of a single CCD camera, separate imaging devices (e.g., two CCD cameras) can be employed, analog imaging devices can also be employed. In accordance with the present invention, any devices and methods can be employed that obtain the simultaneous radiation intensity scattering data by a particle in the overlapping radiation sheets. The velocity components in the plane of the illuminating sheet (y and z directions) would be computed in the usual fashion, and the third velocity component in the direction normal to the illumination sheet (x direction) would be obtained using the ratio method described above to determine the x position of the particle in each of the two exposure sets.

Generation of parallel, offset radiation sheets can be accomplished using a two prism 304, 306 arrangement prior to the sheet generating optics as shown in FIG. 3, or by other methods. For the arrangement shown, the sheet separation is a function of the geometry and index of refraction of the prism material, the radiation wavelength ranges used and the prism separation, and can be calculated by application of Snell's law.

Radiation source(s) 302 for generating two different wavelength range radiation sheets can be multiline lasers or gas lamps such as mercury vapour or sodium lamps, or any other source capable of producing radiation sufficiently intense in at least two wavelength ranges. It is important to note that the resulting radiation sheet intensity distributions need not be Gaussian. All that is necessary is that the intensity ratio of the two wavelength ranges in the sheet overlap region be a monotonic function of position. The two light sources commonly used for PIV imaging are inherently capable of producing at least two colors of light in a coaxial beam. The argon-ion laser is capable of producing a continuous Gaussian beam of several distinct colors, with the two strongest at 488 and 514.5 nm (blue and green respectively). The pulsed Nd-YAG laser commonly used for PIV can easily be configured to produce both 1064 and 532 nm light (near IR and green) in a pulsed Gaussian beam.

Optics to obtain two simultaneous adjacent images on a CCD camera or other imaging device can be obtained commercially (i.e., Princeton Instruments MultiViewer), configured with partially reflecting and fully reflecting mirrors and interference filters as shown schematically in FIG. 3, or by other means.

The sensitivity and range of the method are in large measure determined by the intensity range of the imaging system. If a CCD camera is used, the typical CCD cameras used for PIV have a pixel intensity sensitivity range of 8 to 12 bit (256 to 4096 counts).

An image processed to provide particle sizing information will produce a spatial distribution of particle sizes at an instant in time. The volume of space having sufficient illumination to produce usable particle detection and sizing will be a function of the illumination distribution and the particle size. As with phase Doppler interferometry (PDI) (see Saffman, M., Buchhave, P., Tanger, H., 2^{nd} Int'l Symposium on Applications of Laser Anemometry to Fluid Mechanics, Lisbon, 1984, pp. 1-28, which is incorporated herein by reference in its entirety) the size of the region in space having sufficient illumination to produce a usable signal increases with particle size, thus resulting in a bias towards large particles. In order to correct for this bias, the effective light sheet thickness for each size class must be determined, then the counts in that size class corrected for probe volume variations.

The system detection limits will be controlled in large measure by the dynamic range of the imaging device, typically a CCD camera. If a CCD imaging system is used, the upper detection bound is set by the largest particle in the flow field located in the region of highest illumination intensity. In order to produce a usable signal for this particle, the CCD camera gain would have to be set (through exposure and/or aperture setting) to produce maximum signal without saturation or non-linearity. For a 12-bit camera, this would correspond to an intensity count of approximately 4000. The lower detection bound would be set by the lowest permissible signal that would provide sufficient resolution and signal-to noise ratio, approximately 5 intensity counts on a 12-bit CCD. The maximum scattered radiation intensity that would result from a particle of size dₘₐₓ being imaged when it is located at the illuminating sheet center would be:

Iₘₐₓ=I₀cd²ₘₐₓ(14)

If the CCD gain, exposure and/or lens aperture were set so that this maximum scattered intensity would produce the maximum, unsaturated signal, and defining G as the ratio of maximum, unsaturated signal to lowest acceptable signal, then the minimum acceptable signal from an arbitrarily-sized particle d (<dₘₐₓ) illuminated in radiation sheet 1 would be:

$${I}_{min} = \frac{{I}_{max}}{G} = \frac{{I}_{0} {d}_{max}^{2}}{G} = {I}_{y , 1} exp ( \frac{- 2 {( x + δ )}^{2}}{{t}_{1}^{2}} ) {d}^{2} \qquad ( 15 )$$

The bounding x locations X_{b} in each radiation sheet 1 and 2 beyond which no acceptable signal will result from a particle of size d can be found by rearranging the above and solving for x_{b}:

$$\begin{matrix}{x}_{b1} = \pm \sqrt{- 2 {t}_{1}^{2} ln ( ( \frac{{d}_{max}^{2}}{{d}^{2}} ) ( \frac{1}{G} ) ( \frac{{I}_{0 i}}{{I}_{y1}} ) ) - δ} & ( 16 ) \\ {x}_{b2} = \pm \sqrt{- 2 {t}_{2}^{2} ln ( ( \frac{{d}_{max}^{2}}{{d}^{2}} ) ( \frac{1}{G} ) ( \frac{{I}_{0 i}}{{I}_{y2}} ) ) + δ} & ( 17 )\end{matrix}$$

where I₀ᵢ is the greater of I₀₁ and I₀₂.

The effective thickness of the radiation sheet at a given location is determined by these boundaries. In order to obtain usable data, a particle would have to be located within the detectability bounds for both light sheets. This region would correspond to the following bounds:

$$\begin{matrix}{x}_{b , left} = - \sqrt{- 2 {t}_{2}^{2} ln ( ( \frac{{d}_{max}^{2}}{{d}^{2}} ) ( \frac{1}{G} ) ( \frac{{I}_{0 i}}{{I}_{y2}} ) )} + δ & ( 18 ) \\ {x}_{b , right} = + \sqrt{- 2 {t}_{1}^{2} ln ( ( \frac{{d}_{max}^{2}}{{d}^{2}} ) ( \frac{1}{G} ) ( \frac{{I}_{0 i}}{{I}_{y1}} ) )} - δ & ( 19 )\end{matrix}$$

The effective width of the sheet for a given particle diameter would therefore be:

$$\begin{matrix}W = \sqrt{- 2 {t}_{1}^{2} ln ( ( \frac{{d}_{max}^{2}}{{d}^{2}} ) ( \frac{1}{G} ) ( \frac{{I}_{oi}}{{I}_{y1}} ) )} + \\ \sqrt{- 2 {t}_{2}^{2} ln ( ( \frac{{d}_{max}^{2}}{{d}^{2}} ) ( \frac{1}{G} ) ( \frac{{I}_{oi}}{{I}_{y2}} ) )} - 2 δ\end{matrix} \qquad ( 20 )$$

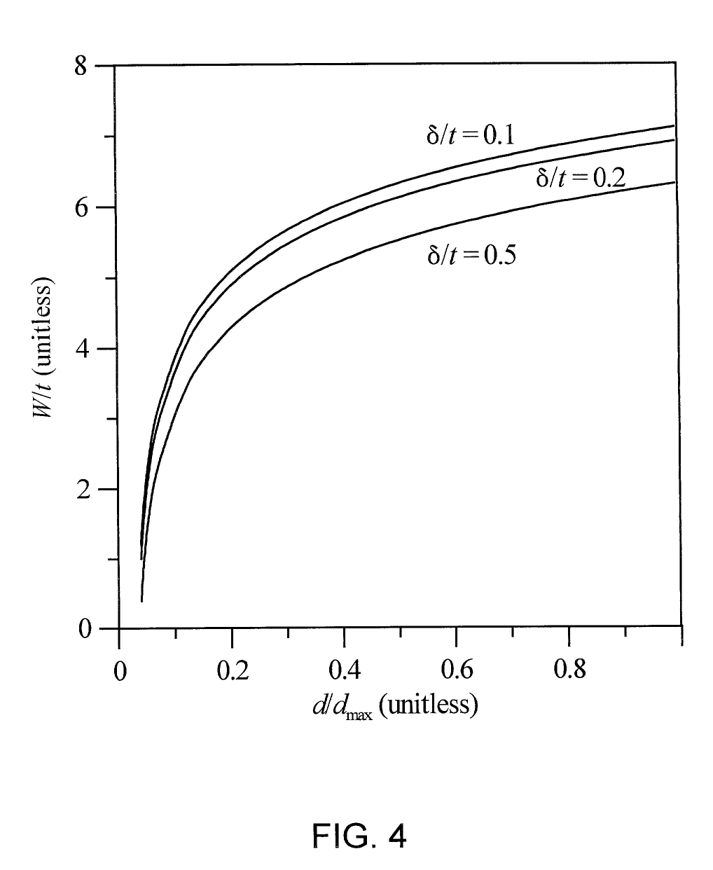

The above equation also dictates the bounds of the sheet separation 67 as a function of sheet thicknesses and desired sizing range for a given set-up. Counts in each size class can then be adjusted accordingly. As W approaches zero for a given size class, particles in that size class would not be visible at all. FIG. 4 presents a plot of W/t as a function of d/dₘₐₓ for various sheet separations, assuming that G=800, t₁=t₂ and I₀₁=I_{y2}.

### EXAMPLES

Preliminary experimental measurements have been made in order to confirm the present invention's ability to unambiguously determine a particle's position in the overlap region of two radiation sheets, and to establish the suitability of the method for particle sizing. A 1 W water-cooled argon ion laser was used to provide green (514.5 nm)and blue (488 nm) radiation sheets. Two prisms were arranged as shown in FIG. 3 and appropriate cylindrical and spherical optics were used to generate radiation sheets approximately 3 mm thick (t =1.5 mm, 1/e²) in the imaging region. Reflecting, opaque spherical test specimens mounted on a micrometer-operated traversing system were translated across the laser sheets at a fixed y plane. Opaque specimens were chosen to prevent complications due to multi-mode scattering and uneven illumination that would occur as the scattering object becomes large in comparison to the laser sheet thickness. A Princeton Instruments MultiViewer equipped with narrow band interference filters at 488 and 514.5 nm was used to produce simultaneous adjacent images on a National Electronics Inc. model NL 2331 analog CCD camera connected to a Grabbit II image capture board with 8 bit intensity resolution. The resulting CCD pixel counts were then used as a relative measure of scattered intensity.

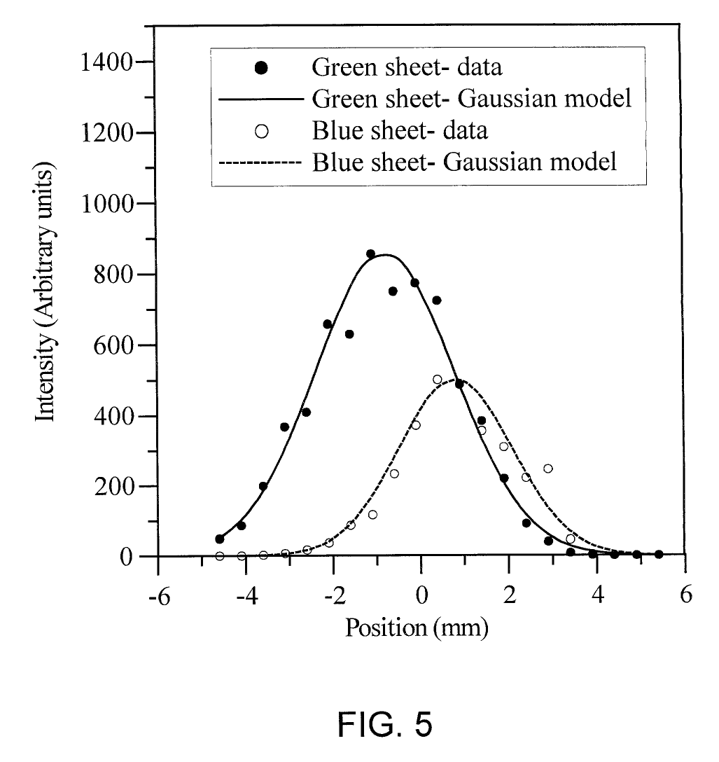

FIG. 5 shows a plot of scattered intensity versus position as the 3.18 mm (⅛″) specimen was traversed through the laser sheets at an arbitrary y position. Superimposed on the data points is a best-fit Gaussian curve with I₀₁=855, t₁=3.2 mm, I₀₂=500, t₂=2.6 and 6=1.3mm, where the subscript 1 corresponds to the green (514.5 nm) sheet and the subscript 2 corresponds to the blue (488.0 nm). As can be seen, modeling the laser sheet intensity distribution in the x direction as a Gaussian is appropriate, although there is some optical noise, particularly at the edges, or wings, of the light sheets.

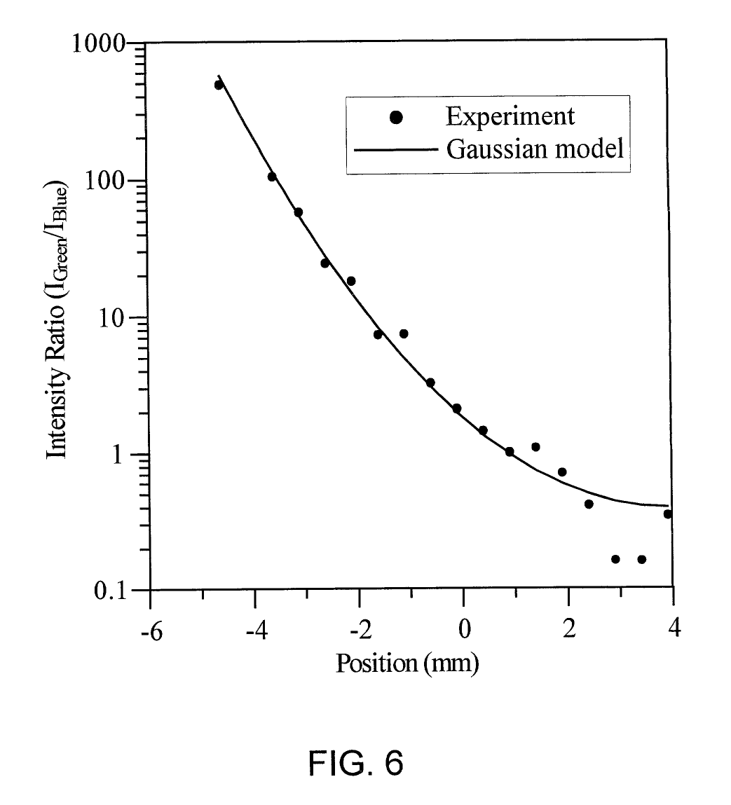

FIG. 6 shows a plot of intensity ratio versus x position across the sheet. As can be seen, the agreement between experimental data and the theoretical, Gaussian-based curve (Equation 8) is very good, particularly given the low resolution of the equipment available. The data fit does deteriorate in the region beyond approximately 8 mm, likely due to the large amount of optical noise and low signal intensity in the “wings” of the laser sheet.

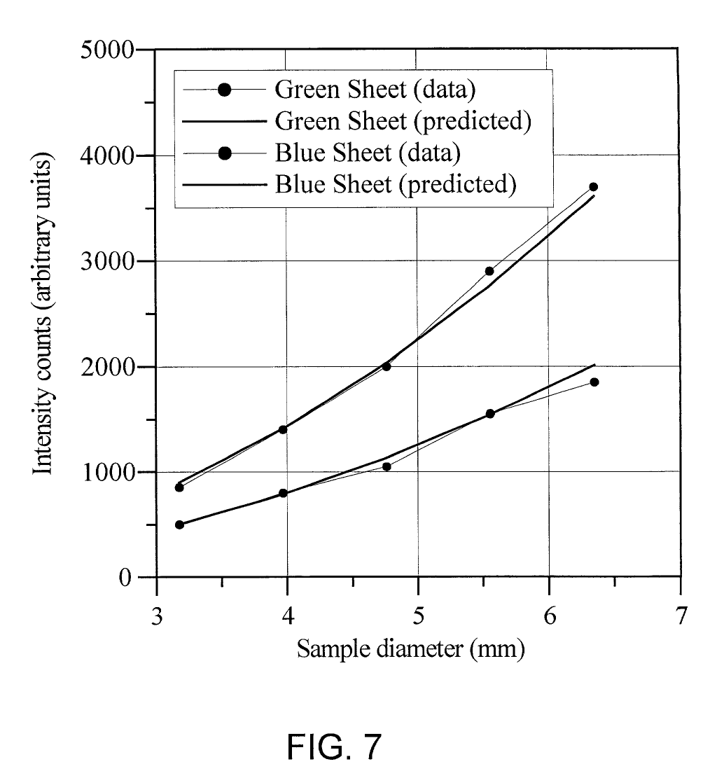

FIG. 7 shows a plot of actual diameter versus expected diameter for several sample sizes located at the same arbitrary position within the laser sheets, based on a calibration using the largest test specimen, 6.35 mm (¼″). Again, the agreement between experiment and theory is extremely good.

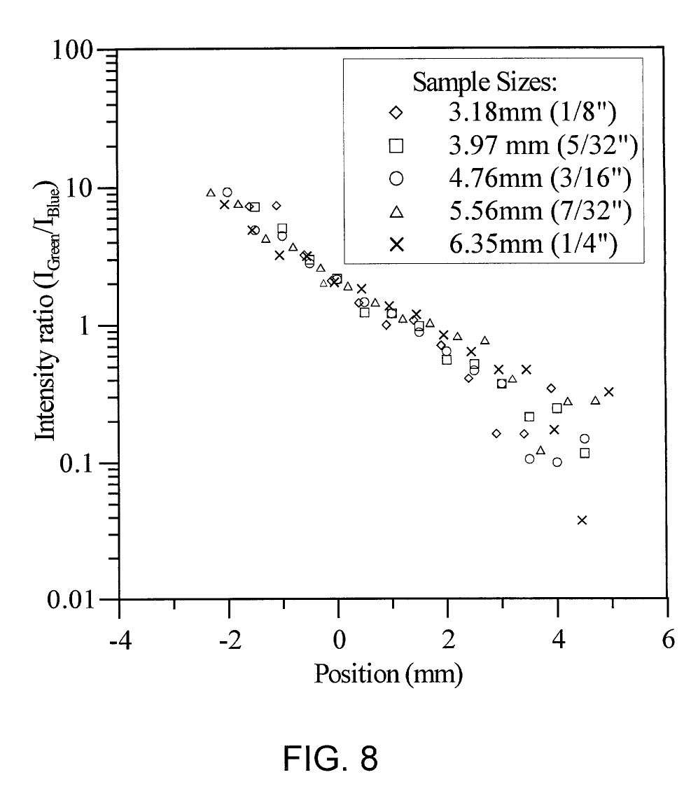

FIG. 8 shows a plot of intensity ratio versus position for all samples tested. As can be seen, this intensity ratio is a monotonic function of position over the range tested for all size specimens. There is some data scatter due to nonuniform illumination as the specimen size becomes large compared with the laser sheet thickness, as well as optical noise and low signal resolution at the edges of the laser sheets. These difficulties should be reduced with optimization of the laser sheet separation distance and other improvements in set-up. In an application involving a spray, the typical particle sizes will be small compared to the sheet thickness.

The present invention of a two wavelength range, overlapped radiation sheet method and apparatus for establishing particle position within the radiation sheets offers a new and useful technique for determining both particle size and the third component of particle position and velocity when used in conjunction with standard PIV systems, with a minimum of additional equipment and processing requirements.

Applications involving transparent particles and coherent radiation sources would require consideration of collection angle to ensure that one scattering mode dominates, to prevent interference from multi-mode scattered radiation at the CCD plane.

Experiments have confirmed that the method and apparatus works well at larger size scales, with no obvious restrictions precluding its extension to typical spray particle sizes. The method appears promising and could result in a very useful enhancement to the already powerful PIV technique.

While various embodiments of the present invention have been described in detail, it is apparent that modifications and adaptations of those embodiments will occur to those skilled in the art. However, it is to be expressly understood that such modifications and adaptations are within the spirit and scope of the present invention. For example, a non-Gaussian radiation intensity distribution can be employed. The present invention can be used with non-collimated radiation sheets. The present invention can be employed with non-parallel radiation sheets. The present invention can be employed with one or more CCD cameras positioned at various collection angles relative to the radiation sheets. The present invention can be employed with more than two radiation sheets having different wavelength ranges. Imaging devices other than CCD cameras can be employed and a wide variety of optics, both to obtain the radiation sheets having different wavelength ranges and to gather the data from the scattered radiation can be employed in the present invention without varying from the spirit and scope thereof.

What is claimed is:

1. A particle measuring apparatus comprising:
(a) a two wavelength range radiation source or sources with optics to provide two offset radiation sheets of different wavelength range and known intensity distribution, directed at the particles to be measured;
(b) a measuring device comprising a CCD camera and filtered image splitter or two separate CCD cameras with filters to provide two sets of two separate, simultaneous images, each of the separate simultaneous images filtered for one of the radiation sheet wavelength ranges, of the particles in the illuminated field with known time interval between the first image set and the second image set; and
(c) a calculating device for calculating the particle size, position and velocity in accordance with the measured particle's scattered radiation intensity and the intensity ratio of each filtered image.

2. The particle measuring apparatus according to claim 1, in which said calculating device calculates the particle's position in the plane of the radiation sheets (y, z) from its position on the image, and its position within the radiation sheets (x) from the intensity ratio of the particle image in the two simultaneous filtered images, when said known intensity distribution is a Gaussian intensity distribution, as follows:
$$\frac{{I}_{1} ( x , y , z )}{{I}_{2} ( x , y , z )} = \frac{{I}_{y , z , 1}}{{I}_{y , z , 2}} exp [ - 2 ( \frac{{( a + δ )}^{2}}{{t}_{1}^{2}} - \frac{{( x - δ )}^{2}}{{t}_{2}^{2}} ) ]$$
wherein
y: position in plane of radiation sheet normal to direction of propagation
z: position in direction of propagation of radiation sheets
x: position within radiation sheet normal to radiation sheet plane
I₁(x,y,z): measured intensity of radiation scattered from particle (located at x,y,z) image in image 1
I₂(x,y,z): measured intensity of radiation scattered from particle (located at x,y,z) image in image 2
I_{y,z,1}/I_{y,z,2}: measured peak intensity ratio of radiation sheets of wavelength ranges 1 and 2 at location y,z
δ: half-separation between radiation sheets of different wavelength ranges
t₁: radiation sheet (wavelength range 1) half-thickness
t₂: radiation sheet (wavelength range 2) half-thickness.

3. The particle measuring apparatus according to claim 1, in which said calculating device calculates the particle's velocity by comparing the particle position in said first image set to the corresponding position in said second image set, thus determining the particle's displacement in three dimensions, then dividing by the time interval between image sets, thus determining the particle's velocity.

4. The particle measuring apparatus according to claim 1, in which said calculating device calculates the particle's size by comparing the particle image intensity to that of a reference calibration particle in accordance with:
$$\begin{matrix}\frac{{d}^{2}}{{d}_{ref}^{2}} = \frac{I ( x , y , d )}{{I}_{ref} ( {x}_{ref} , {y}_{ref} , {d}_{ref} )} \cdot \\ exp [ \frac{2 ( {y}^{2} - {y}_{ref}^{2} )}{{h}^{2}} - \frac{2 [ {( {x}_{ref} + δ )}^{2} - {( x + δ )}^{2} ]}{{t}^{2}} ]\end{matrix}$$
wherein
d: particle size
d_{ref}: reference particle size
I(x,y,d): measured intensity of radiation scattered from a particle of size d located at (x,y,z)
I_{ref}(x_{ref},y_{ref},d_{ref}): measured intensity of radiation scattered from reference particle
h: radiation sheet half-height.
t: radiation sheet half-thickness

5. An apparatus for determining the size and position of at least one particle comprising:
(a) at least one radiation source capable of providing two overlapping offset radiation sheets of different wavelengths and known nonuniform intensity distribution;
(b) a device for measuring the radiation intensity scattered by a particle passing through the two radiation sheets; and
(c) a device for calculating particle size and position in accordance with the measured particle's scattered radiation intensity and the intensity ratio from each of the radiation sheets.

6. The apparatus of claim 5, wherein said radiation source comprises optics to provide two overlapping, offset radiation sheets of different wavelengths and known nonuniform intensity distribution.

7. The apparatus of claim 5, wherein said known nonuniform intensity distribution is a Gaussian distribution.

8. The apparatus of claim 5, wherein said device for measuring the scattered radiation intensity comprises a CCD camera and filtered image splitter or two separate CCD cameras with filters capable of providing two separate, simultaneous images, each filtered for one of the radiation sheet wavelength ranges.

9. The apparatus of claim 5, wherein said device for calculating particle size or position calculates the particle's position in the plane of the radiation sheets in the z and y directions from the particle's position on the image, and the particle's position within the radiation sheets in the x direction from the intensity ratio of the particle image in the two filtered images, wherein y is the position in the plane of the light sheet normal to the direction of propagation and z is the position in the direction of propagation of the light sheets and x is the position within the light sheet normal to the light sheet plane.

10. The apparatus of claim 5, wherein said radiation source comprises a laser.

11. The apparatus of claim 5, wherein said radiation source comprises optics to generate said radiation sheets.

12. The apparatus of claim 11, wherein said optics comprise two prisms.

13. The apparatus of claim 5, wherein said radiation source comprises a radiation source selected from the group comprising multiline lasers and gas lamps.

14. The apparatus of claim 5, wherein the intensity ratio of the two color sheets' overlap region is a monotonic function of position.

15. The apparatus of claim 11, wherein said optics comprise cylindrical and Spherical optics to generate the desired light sheets.

16. The apparatus of claim 5, wherein said radiation source is selected from the group comprising a single radiation source capable of emitting radiation in two different wavelength ranges or two separate radiation sources capable of providing radiation in two different wavelength ranges.

17. A method for determining the size or position of at least one particle comprising the steps of:
(a) providing two overlapping offset radiation sheets of different wavelengths and known nonuniform intensity distribution;
(b) measuring the radiation intensity scattered by a particle passing through the two radiation sheets; and
(c) calculating at least one of particle size and position in accordance with the measured particle's scattered radiation intensity and the intensity ratio from each of the radiation sheets.

18. The method of claim 17, wherein said step of calculating comprises calculating particle position in the plane of the radiation sheets in the z- and y- directions from the particle's position on the image, and the particle's position within the radiation sheets in the x- direction from the intensity ratio of the particle image in the two filtered images, wherein y- is the position in the plane of the light sheet normal to the direction of propagation and z- as the position in the propagation of the light sheets and x- is the position within the light sheet normal to the light sheet plane.

19. The method of claim 17, wherein at least one of particle position and velocity in three dimensions and particle size are calculated.

20. The method of claim 18, wherein all of particle position and velocity in three dimensions and particle size are calculated.
